(19) United States
(12) Patent Application Publication
(10) Pub. No.: US 2026/0178340 A1
(43) Pub. Date: Jun. 25, 2026

(54) METHOD AND DEVICE FOR AUTOMATICALLY INTEGRATING HARDWARE BASED ON CONFIGURATION FILE

(71) Applicant: SAMSUNG ELECTRONICS CO., LTD., Suwon-si (KR)

(72) Inventors: Jaehyung JANG, Suwon-si (KR); Sangyoon LEE, Suwon-si (KR); Jaejun CHANG, Suwon-si (KR); Taesin HA, Suwon-si (KR)

(73) Assignee: SAMSUNG ELECTRONICS CO., LTD., Suwon-si (KR)

(21) Appl. No.: 19/239,322

(22) Filed: Jun. 16, 2025

(30) Foreign Application Priority Data
Dec. 23, 2024 (KR) 10-2024-0194509

(51) Int. Cl. G06F 9/4401

(52) U.S. Cl. CPC G06F 9/4401

(57) ABSTRACT

A method and device for automatically integrating hardware based on a configuration file are provided. The method includes generating the configuration file for the hardware including a model name of the hardware, connection information about the hardware, and a control command for the hardware and generating an application programming interface (API) for each control command included in the configuration file by using the configuration file.

### CROSS-REFERENCE TO RELATED APPLICATION

This application claims priority from Korean Patent Application No. 10-2024-0194509, filed on Dec. 23, 2024, in the Korean Intellectual Property Office, the entire disclosure of which is incorporated herein by reference for all purposes.

### BACKGROUND

### 1. Field

One or more embodiments relate to a method and device for automatically integrating hardware based on a configuration file.

### 2. Description of the Related Art

In existing manufacturing and process systems, there are various automation systems that connect and integrate multiple devices. For example, a cluster tool controller (CTC) is used in semiconductor processes, and a manufacturing execution system (MES) is used in other manufacturing processes. These systems are designed to integrate and control multiple devices and automatically perform a series of processes.

However, in order to implement these systems and even with those various automation systems, multiple experts may still need to review device documentation, understand control methods and communication rules of each device, and program the control methods and communication rules to correspond to the system and avoid errors, inaccuracies, or the like in inputs and outputs of those various automation systems. Particularly, since a device of each manufacturer has different control commands and communication methods, each device needs to be integrated in a different method. For example, among IKA's heater commands, “OUT_SP_66” is a command that sets a target temperature and has different rules than those of devices from other manufacturers.

In this integration process, time and cost increases as the number of devices increases, which reduces flexibility of the system. To solve this issue, ABB Schweiz AG group has recently proposed an interface standard called a module type package (MTP). This technology aims to standardize connection between device manufacturers, system integrators, and plant operators, thereby increasing efficiency at each location and increasing efficiency of system integration and operation.

Conventional integration methods require a lot of physical time since the methods are performed directly by people for each device, flexibility of the system is low, and the various automation systems may still have errors or require manual adjustment to account for those computer errors. When the flexibility becomes low, there is no significant impact on simple manufacturing processes, but low flexibility acts as a major weakness in intelligent closed-loop systems such as research platforms that require real-time changes in process sequences or conditions according to process results.

In the research platforms, flexible system integration is essential to perform various methods and derive optimal results. However, conventional methods do not support the flexible system integration efficiently. Particularly, when the communication rules and control methods of each device are not standardized, this integration work requires a lot of time and limits the flexibility of the process.

The above information may be presented as the related art to help with the understanding of the disclosure. No arguments or decisions are raised to whether any of the above description is applicable as the prior art related to the present disclosure.

### SUMMARY

One or more embodiments may address at least the above problems and/or disadvantages and other disadvantages not described above. Also, the embodiments are not required to overcome the disadvantages described above, and an embodiment may not overcome any of the problems described above.

There is provided a method of automatically integrating a hardware based on a configuration file, the method including: generating the configuration file of the hardware and including a model name of the hardware, connection information about the hardware, and a control command of the hardware; and generating an application programming interface (API) as an interface in relation to each control command included in the configuration file by using the configuration file, the each control command including the control command of the hardware.

Generating the configuration file of the hardware may include: collecting information about the hardware; obtaining the model name of the hardware, the connection information about the hardware, and the control command of the hardware from the information about the hardware; and generating the configuration file in a preset form including the connection information, the model name, and the control command.

Generating the configuration file of the hardware may include: detecting a connection to the hardware and obtaining the connection information about the hardware based on detecting the connection; obtaining the model name of the hardware; searching for and obtaining a manual of the hardware using the model name; obtaining the control command from the manual; and generating the configuration file in a preset form including the connection information, the model name, and the control command.

Generating the API may include confirming the connection information in the configuration file, generating an endpoint of the connection information and the each control command included in the configuration file, and generating the API in relation to the each control command included in the configuration file.

The configuration file may include the model name of the hardware, the connection information about the hardware, and the control command, and the control command may include at least one of: a set command configured to command an operation of the hardware; and a get command configured to read a value from the hardware.

The set command may include: a name of an abstracted command; a command to be actually called; and a parameter included when the command requires a parameter.

The get command may include: a name of an abstracted command; a command to be actually called; and a value to be read.

The method may also include generating a library of the hardware by collecting the API for the each control command.

The method may also include generating a graphical user interface (GUI) block configured to provide the API in relation to the each control command as a GUI.

The API may be a representational state transfer (REST) API configured to define the hardware on web and transmit and receive the control command of the hardware using a standard hypertext transfer protocol (HTTP) method, the library of the hardware generated by collecting the API for the each control command may include a python package, and a GUI block configured to provide the API for the each control command as a GUI may be generated by using React or JavaScript.

There is provided a non-transitory computer-readable storage medium storing instructions that, when executed by a processor, cause the processor to perform a method of automatically integrating a hardware based on a configuration file, the method including: generating the configuration file of the hardware and including a model name of the hardware, connection information about the hardware, and a control command of the hardware; and generating an application programming interface (API) as an interface in relation to each control command included in the configuration file by using the configuration file, the each control command including the control command of the hardware.

There is provided an electronic device configured to automatically integrate a hardware based on a configuration file, the electronic device including: a communicator configured to communicate with the hardware; one or more processors; and a memory configured to store instructions, wherein the instructions, when executed by the one or more processors, cause the electronic device to perform: generating the configuration file of the hardware and including a model name of the hardware, connection information about the hardware, and a control command of the hardware; and generating an application programming interface (API) as an interface in relation to each control command included in the configuration file by using the configuration file, the each control command including the control command of the hardware.

Generating the configuration file of the hardware may include: collecting information about the hardware; obtaining the model name of the hardware, the connection information about the hardware, and the control command of the hardware from the information about the hardware; and generating the configuration file in a preset form including the connection information, the model name, and the control command.

Generating the configuration file of the hardware may include detecting a connection to the hardware and obtaining the connection information about the hardware based on detecting the connection; obtaining the model name of the hardware; searching for and obtaining a manual of the hardware using the model name; obtaining the control command from the manual; and generating the configuration file in a preset form including the connection information, the model name, and the control command.

Generating the API may include confirming the connection information in the configuration file, generating an endpoint of the connection information and the each control command included in the configuration file, and generating the API in relation to the each control command included in the configuration file.

The configuration file may include the model name of the hardware, the connection information about the hardware, and the control command, and the control command may include at least one of: a set command configured to command an operation of the hardware; and a get command configured to read a value from the hardware.

The set command may include: a name of an abstracted command; a command to be actually called; and a parameter included when the command requires a parameter.

The get command may include: a name of an abstracted command; a command to be actually called; and a value to be read.

The instructions, when executed by the one or more processors, may also cause the electronic device to perform generating a library of the hardware by collecting the API for the each control command.

The instructions, when executed by the one or more processors, may also cause the electronic device to perform generating a graphical user interface (GUI) block configured to provide the API in relation to the each control command as a GUI.

Additional aspects of embodiments will be set forth in part in the description which follows and, in part, will be apparent from the description, or may be learned by practice of the disclosure.

### BRIEF DESCRIPTION OF THE DRAWINGS

With regard to the description of the drawings, the same or similar reference numerals may be used to refer to the same or similar components.

The above and/or other aspects will be more apparent by describing certain embodiments with reference to the accompanying drawings, in which:

FIG. 1 is a flowchart illustrating a method of automatically integrating hardware based on a configuration file in an integration device, according to one or more embodiments;

FIG. 2 is a diagram illustrating information included in a configuration file, according to one or more embodiments;

FIG. 3 is a diagram illustrating an example of a configuration file according to one or more embodiments;

FIG. 4 is a diagram illustrating an example of a configuration file according to one or more embodiments;

FIG. 5 is a diagram illustrating an example of a configuration file according to one or more embodiments;

FIG. 6 is a flowchart illustrating a method of generating a configuration file by collecting hardware information in an integration device, according to one or more embodiments;

FIG. 7 is a flowchart illustrating a method of generating a configuration file of connected hardware in an integration device, according to one or more embodiments;

FIG. 8 is a flowchart illustrating a method of generating an API in an integration device, according to one or more embodiments;

FIG. 9 is a diagram illustrating a configuration of an integration device, according to one or more embodiments; and

FIG. 10 is a diagram illustrating an example of controlling hardware by an integration device, according to one or more embodiments.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless otherwise mentioned, the descriptions on the embodiments may be applicable to the following embodiments and thus, duplicated descriptions will be omitted for conciseness.

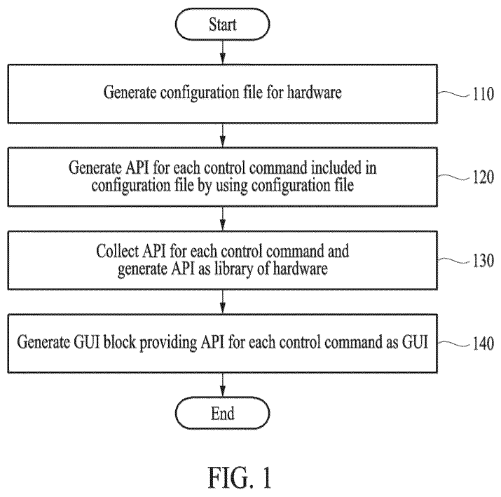

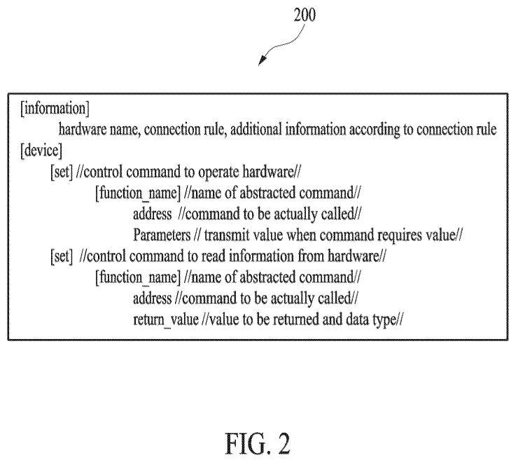

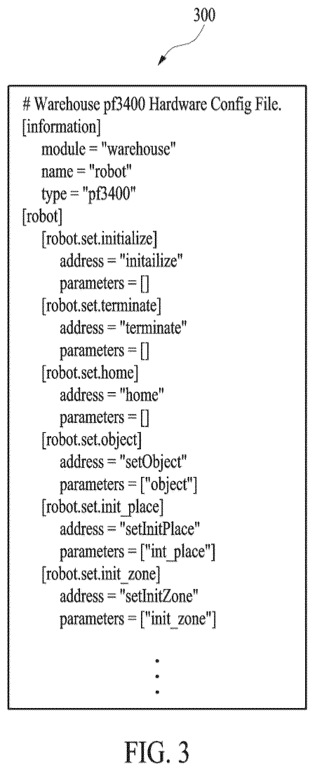

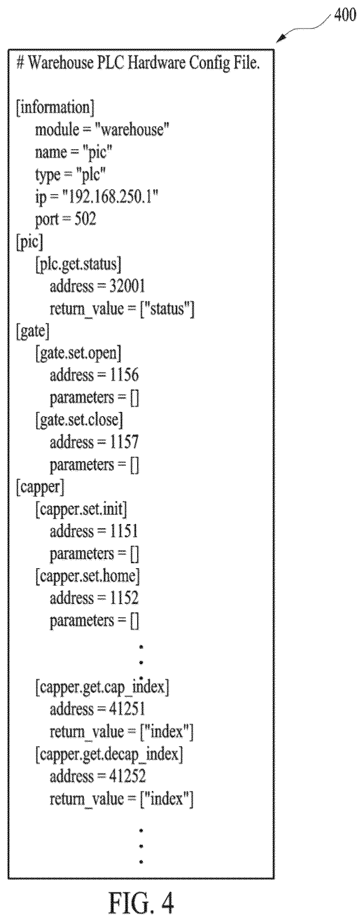

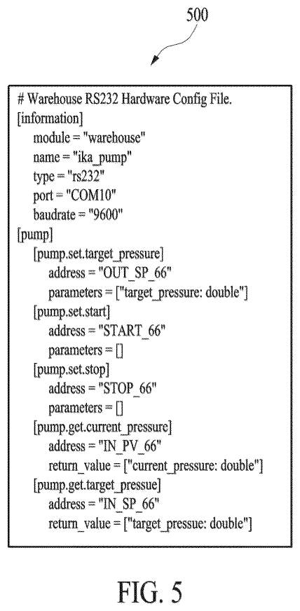

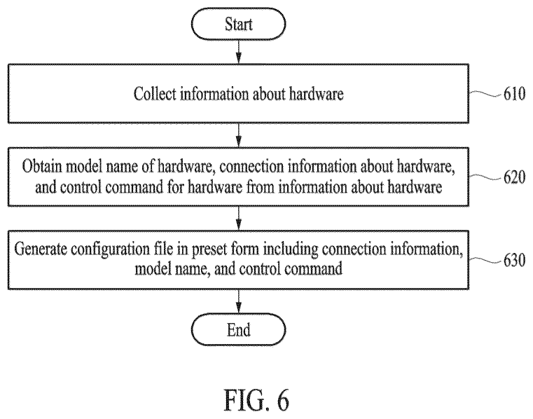

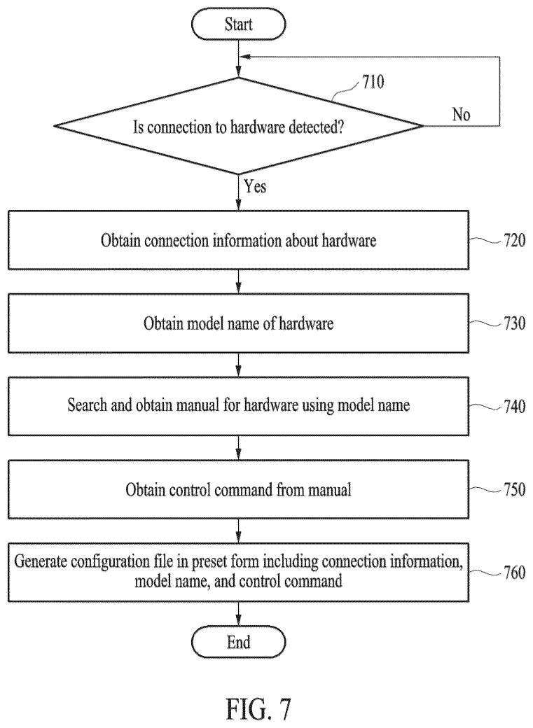

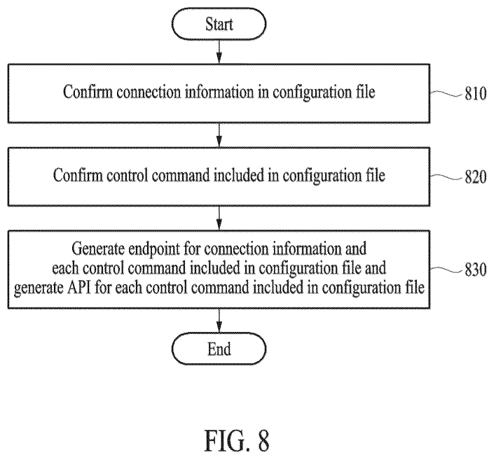

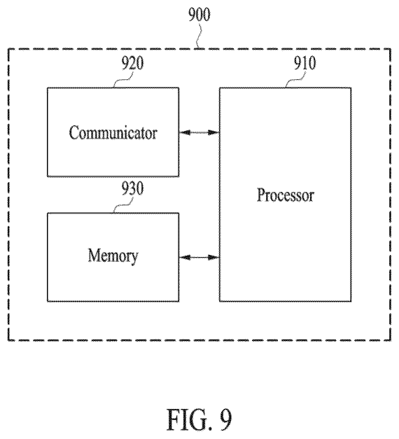

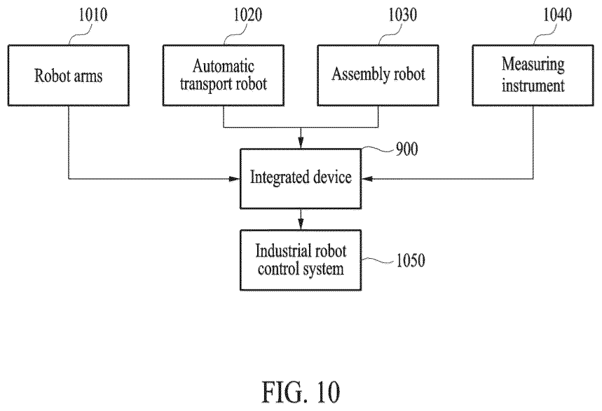

Hereinafter, a method and device for automatically integrating hardware based on a configuration file are described in detail with reference to FIG. 1, FIG. 2, FIG. 3, FIG. 4, FIG. 5, FIG. 6, FIG. 7, FIG. 8, FIG. 9, and FIG. 10. In the description of the present disclosure, a device for automatically integrating hardware is described as an integration device.

FIG. 1 is a flowchart illustrating a method of automatically integrating hardware based on a configuration file in an integration device, according to one or more embodiments.

Referring to FIG. 1, in operation 110, the integration device may generate the configuration file for the hardware including a model name of the hardware, connection information about the hardware, and a control command for the hardware.

Here, the configuration file may include the model name of the hardware, the connection information about the hardware, and the control command. The configuration file is described in detail below with reference to FIG. 2. In addition, operation 110 of generating the configuration file is described in detail below with reference to FIG. 6 and FIG. 7.

In operation 120, the integration device may generate an application programming interface (API) for each control command included in the configuration file by using the configuration file. For example, the API may be a representational state transfer (REST) API that defines the hardware on the web and transmits and receives the control command for the hardware using a standard hypertext transfer protocol (HTTP) method. Here, operation 120 of generating the API is described in more detail below with reference to FIG. 8.

In operation 130, the integration device may generate a library of the hardware by collecting the API for the each control command. Here, the library may include, for example, a python package.

In operation 140, the integration device may generate a graphical user interface (GUI) block that provides the API for the each control command as a GUI. Here, the GUI block may be generated by using, for example, React or JavaScript.

FIG. 2 is a diagram illustrating information included in a configuration file, according to one or more embodiments.

Referring to FIG. 2, it may be confirmed that a configuration file 200 is divided into an [information] area and a [device] area.

The [information] area of the configuration file 200 may include a name (or a model name) of hardware and connection information related to connection rules of the hardware.

The [device] area of the configuration file 200 may include a control command.

Here, the control command may include at least one of a set command that commands an operation of the hardware or a get command that reads a value from the hardware. Here, the set command may include a name of an abstracted command, a command to be actually called, and a parameter included when the command requires a parameter. In addition, the get command may include a name of an abstracted command, a command to be actually called, and a value to be read.

FIG. 3 is a diagram illustrating an example of a configuration file according to one or more embodiments.

Referring to FIG. 3, a configuration file 300 may call operation functions of a robot (model name: PF3400).

Communication rules of the configuration file 300 may be generated according to a Transmission Control Protocol/Internet Protocol (TCP/IP) communication standard, but information regarding the TCP/IP communication standard may be embedded in another code, and the communication rules of configuration file 300 may only play the role of calling the information here.

Since the control command of the configuration file 300 calls an operation function by a function name, a function name such as “setObject” may be entered in an address, and a robot position value may be entered in a parameter.

FIG. 4 is a diagram illustrating an example of a configuration file according to one or more embodiments.

Referring to FIG. 4, a configuration file 400 may control connected devices by an industrial control device (a programmable logic controller (PLC)).

The industrial control device may use a Modbus standard, so an address of the configuration file 400 may include a Modbus address such as address 1151 and address 41251.

FIG. 5 is a diagram illustrating an example of a configuration file according to one or more embodiments.

Referring to FIG. 5, a configuration file 500 may control a pump of IKA.

The pump of IKA may use an RS232 standard and may then communicate with a string such as “OUT_SP_66” in an address of the configuration file 500.

FIG. 6 is a flowchart illustrating a method of generating a configuration file by collecting information about hardware in an integration device, according to one or more embodiments.

Referring to FIG. 6, in operation 610, the integration device may collect the information about the hardware. Here, the information about the hardware may receive information collected by a user or an administrator, and the information about the hardware may be a hardware manual.

In operation 620, the integration device may obtain the model name of the hardware, connection information about the hardware, and a control command for the hardware from the information about the hardware.

In operation 630, the integration device may generate a configuration file in a preset form including the connection information, the model name, and the control command.

FIG. 7 is a flowchart illustrating a method of generating a configuration file of connected hardware in an integration device, according to one or more embodiments.

Referring to FIG. 7, in operation 710, the integration device may confirm whether the integration device is connected to the hardware.

When connection to the hardware is detected as a result of the confirming in operation 710, the integration device may obtain connection information about the hardware in operation 720. For example, the integration device may automatically search for a product identification (PID)/vender identification (VID) when a universal serial bus (USB) device is connected. The integration device may automatically search for IP/PORT when a network device is connected.

In operation 730, the integration device may obtain a model name of the hardware. For example, the integration device may identify the model name of the connected hardware through the PID/VID when the USB device is connected. The integration device may identify the model name and manufacturer information by using Simple Network Management Protocol (SNMP), multicast Domain Name System (mDNS), and HTTP Banner Grabbing technologies on IP/PORT when the network device is connected.

In operation 740, the integration device may search for and obtain a manual for the hardware using the model name. For example, the integration device may generate queries to search for the manual using the model name of identified hardware by using artificial intelligence (e.g., a large language model (LLM)) and may download the manual.

In operation 750, the integration device may obtain the control command from the manual. For example, the integration device may extract the control command, protocol information, and the connection information from the manual by using artificial intelligence (e.g., a large language model (LLM)).

In operation 760, the integration device may generate the configuration file in a preset form including the connection information, the model name, and the control command.

FIG. 8 is a flowchart illustrating a method of generating an API in an integration device, according to one or more embodiments.

Referring to FIG. 8, in operation 810, the integration device may confirm connection information in a configuration file.

In operation 820, the integration device may confirm the control command included in the configuration file.

In operation 830, the integration device may generate an endpoint for the connection information and each control command included in the configuration file and may generate the API for the each control command included in the configuration file.

FIG. 9 is a diagram illustrating a configuration of an integration device, according to one or more embodiments.

Referring to FIG. 9, an integration device 900 may include a processor 910, a communicator 920, and a memory 930.

The communicator 920 may support establishing a direct (e.g., wired) communication channel or wireless communication channel between the integration device 900 and an external electronic device (e.g., hardware or server) and performing communication through the established communication channel. The communicator 920 may include one or more communication processors that operate independently of the processor 910 (e.g., an application processor) and support direct (e.g., wired) communication or wireless communication. According to one or more embodiments, the communicator 920 may include a wireless communication module (e.g., a cellular communication module, a short-range wireless communication module, or a global navigation satellite system (GNSS) communication module) or a wired communication module (e.g., a local area network (LAN) communication module, or a power line communication (PLC) module). A corresponding one of these communication modules may communicate with the hardware via a short-range communication network (e.g., Bluetooth™, wireless-fidelity (Wi-Fi) direct, or infrared data association (IrDA)) or a long-range communication network (e.g., a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other.

The memory 930 may store a variety of data used by at least one component (e.g., the processor 910) of the integration device 900. The variety of data may include, for example, software and input data or output data for instructions related thereto. The memory 930 may include a volatile memory or a non-volatile memory.

The processor 910 may generate a configuration file for the hardware including a model name of the hardware, connection information about the hardware, and a control command for the hardware and may generate an API for each control command included in the configuration file by using the configuration file. Here, the configuration file may include the model name of the hardware, the connection information about the hardware, and the control command. For example, the API may be a REST API that defines the hardware on the web and transmits and receives the control command for the hardware using a standard HTTP method.

In addition, the processor 910 may generate a library of the hardware by collecting the API for the each control command and may generate a GUI block that provides the API for the each control command as a GUI. Here, the library may include, for example, a python package. Furthermore, the GUI block may be generated by using, for example, React or JavaScript.

The processor 910 may collect information about the hardware, may obtain the model name of the hardware, the connection information about the hardware, and the control command for the hardware from the information about the hardware, and may generate the configuration file in a preset form including the connection information, the model name, and the control command.

When connection to the hardware is detected, the processor 910 may obtain the connection information about the hardware, may obtain the model name of the hardware, may search for and obtain a manual for the hardware using the model name, may obtain the control command from the manual for the hardware, and may generate the configuration file in a preset form including the connection information, the model name, and the control command.

When the API is generated, the processor 910 may confirm the connection information and the control command in the configuration file, may generate an endpoint for the connection information and each control command included in the configuration file, and may generate the API for the each control command included in the configuration file.

FIG. 10 is a diagram illustrating an example of controlling hardware by an integration device, according to one or more embodiments.

Referring to FIG. 10, the integration device 900 may obtain information about each piece of hardware from hardware devices to be integrated, which are robot arms 1010, an automatic transport robot 1020, an assembly robot 1030, and a measuring instrument 1040, and may generate configuration information about each piece of hardware using the obtained information about each piece of hardware.

The integration device 900 may generate an API corresponding to each piece of hardware using the configuration information about each of the robot arms 1010, the automatic transport robot 1020, the assembly robot 1030, and the measuring instrument 1040 and may generate a library and a GUI block using the API.

The integration device 900 may build an industrial robot control system 1050 by providing a user with the API, the library, or the GUI block for each of the robot arms 1010, the automatic transport robot 1020, the assembly robot 1030, and the measuring instrument 1040.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or rearranged or supplemented by other components or their equivalents.

Therefore, other implementations, other embodiments, and equivalents to the claims are also within the scope of the following claims.

What is claimed is:

1. A method of automatically integrating a hardware based on a configuration file, the method comprising:
generating the configuration file of the hardware and including a model name of the hardware, connection information about the hardware, and a control command of the hardware; and
generating an application programming interface (API) as an interface in relation to each control command included in the configuration file by using the configuration file, the each control command including the control command of the hardware.

2. The method of claim 1, wherein
generating the configuration file of the hardware comprises:
collecting information about the hardware;
obtaining the model name of the hardware, the connection information about the hardware, and the control command of the hardware from the information about the hardware; and
generating the configuration file in a preset form including the connection information, the model name, and the control command.

3. The method of claim 1, wherein
generating the configuration file of the hardware comprises:
detecting a connection to the hardware and obtaining the connection information about the hardware based on detecting the connection;
obtaining the model name of the hardware;
searching for and obtaining a manual of the hardware using the model name;
obtaining the control command from the manual; and
generating the configuration file in a preset form including the connection information, the model name, and the control command.

4. The method of claim 1, wherein
generating the API comprises confirming the connection information in the configuration file, generating an endpoint of the connection information and the each control command included in the configuration file, and generating the API in relation to the each control command included in the configuration file.

5. The method of claim 1, wherein
the configuration file comprises the model name of the hardware, the connection information about the hardware, and the control command, and
the control command comprises at least one of:
a set command configured to command an operation of the hardware; and
a get command configured to read a value from the hardware.

6. The method of claim 5, wherein
the set command comprises:
a name of an abstracted command;
a command to be actually called; and
a parameter included when the command requires a parameter.

7. The method of claim 5, wherein
the get command comprises:
a name of an abstracted command;
a command to be actually called; and
a value to be read.

8. The method of claim 1, further comprising:
generating a library of the hardware by collecting the API for the each control command.

9. The method of claim 1, further comprising:
generating a graphical user interface (GUI) block configured to provide the API in relation to the each control command as a GUI.

10. The method of claim 1, wherein
the API is a representational state transfer (REST) API configured to define the hardware on web and transmit and receive the control command of the hardware using a standard hypertext transfer protocol (HTTP) method,
a library of the hardware generated by collecting the API for the each control command includes a python package, and
a GUI block configured to provide the API for the each control command as a GUI is generated by using React or JavaScript.

11. A non-transitory computer-readable storage medium storing instructions that, when executed by a processor, cause the processor to perform the method of claim 1.

12. An electronic device configured to automatically integrate a hardware based on a configuration file, the electronic device comprising:
a communicator configured to communicate with the hardware;
one or more processors; and
a memory configured to store instructions,
wherein the instructions, when executed by the one or more processors, cause the electronic device to perform:
generating the configuration file of the hardware and including a model name of the hardware, connection information about the hardware, and a control command of the hardware; and
generating an application programming interface (API) as an interface in relation to each control command included in the configuration file by using the configuration file, the each control command including the control command of the hardware.

13. The electronic device of claim 12, wherein
generating the configuration file of the hardware comprises:
collecting information about the hardware;
obtaining the model name of the hardware, the connection information about the hardware, and the control command of the hardware from the information about the hardware; and
generating the configuration file in a preset form including the connection information, the model name, and the control command.

14. The electronic device of claim 12, wherein
generating the configuration file of the hardware comprises:
detecting a connection to the hardware and obtaining the connection information about the hardware based on detecting the connection;
obtaining the model name of the hardware;
searching for and obtaining a manual of the hardware using the model name;
obtaining the control command from the manual; and
generating the configuration file in a preset form including the connection information, the model name, and the control command.

15. The electronic device of claim 12, wherein
generating the API comprises confirming the connection information in the configuration file, generating an endpoint of the connection information and the each control command included in the configuration file, and generating the API in relation to the each control command included in the configuration file.

16. The electronic device of claim 12, wherein
the configuration file comprises the model name of the hardware, the connection information about the hardware, and the control command, and
the control command comprises at least one of:
a set command configured to command an operation of the hardware; and
a get command configured to read a value from the hardware.

17. The electronic device of claim 16, wherein
the set command comprises:
a name of an abstracted command;
a command to be actually called; and
a parameter included when the command requires a parameter.

18. The electronic device of claim 16, wherein
the get command comprises:
a name of an abstracted command;
a command to be actually called; and
a value to be read.

19. The electronic device of claim 12, wherein
the instructions, when executed by the one or more processors, cause the electronic device to perform generating a library of the hardware by collecting the API for the each control command.

20. The electronic device of claim 12, wherein
the instructions, when executed by the one or more processors, cause the electronic device to perform generating a graphical user interface (GUI) block configured to provide the API in relation to the each control command as a GUI.
